(19) United States
(12) Patent Application Publication
(10) Pub. No.: US 2017/0157749 A1
(43) Pub. Date: Jun. 8, 2017

(54) Faucet Supply Line Wrench

(71) Applicant: Aaron W Levy, Seattle, WA (US)

(72) Inventor: Aaron W Levy, Seattle, WA (US)

(21) Appl. No.: 15/369,612

(22) Filed: Dec. 5, 2016

Related U.S. Application Data
(60) Provisional application No. 62/263,367, filed on Dec. 4, 2015.

(51) Int. Cl. B25B 13/48; B25B 23/10; B25G 1/00

(52) U.S. Cl. CPC B25B 13/481; B25G 1/005; B25B 23/105

(57) ABSTRACT

An apparatus to be used as an alternative for a wrench contains a fastener receiving head, a tubular body, a receiving channel, a first arm, and a second arm. The fastener receiving head is terminally connected to the tubular body and is designed to fit around a bolt head. The receiving channel traverses through the tubular body and the fastener receiving head so that a supply line associated with a faucet setup can be positioned within the receiving channel. The first arm and the second arm are perpendicularly connected to the tubular body so that the tubular body can be rotated by holding the first arm and the second arm.

The current application claims a priority to the U.S. Provisional Patent application Ser. No. 62/263,367 filed on Dec. 4, 2015. The current application is filed on the next business day, which is Dec. 5, 2016, while Dec. 4, 2016 was on a weekend.

### FIELD OF THE INVENTION

The present invention relates generally to an apparatus that can be used as an alternative to a wrench. More specifically, the present invention introduces a wrench that is specifically designed for standard faucet supply lines.

### BACKGROUND OF THE INVENTION

Wrenches are generally used as a tool to provide grip and mechanical advantage when applying torque to turn objects. Depending on the need, different types of wrenches can be used. As an example, the length of the handle can vary from one wrench to another. In another instance, the open end of the wrench can be different. Even though existing wrench designs are effective on completing many tasks, certain issues cannot be addressed by most wrenches.

Most wrenches are designed to have an open end to engage with the nut or bolt and a handle. This design can be very effective when being used on a nut or bolt which is easily accessible and when the bolt is in an open space in which the wrench handle can be moved. However, when the nut or bolt is in a tight space, using a wrench with a long handle may not be possible. Even though a wrench with a shorter handle can be used, the required mechanical advantage may not be achieved with the shorter handle.

The lack of operating space can occur due to different reasons. As an example, the desired nut or bolt can be positioned against a wall. In another instance, another fitting can be in the way of the desired nut or bolt. The present invention is intended to be used with faucet supply lines. When used with faucet supply lines, the supply line or a wall is in the operating space of the wrench on most occasions. Since existing wrenches cannot address the issue effectively, special tools or expert knowledge is required and can be time consuming and financially disadvantageous. Therefore, the need for an appropriately designed wrench is clearly evident.

The objective of the present invention is to address the aforementioned issues. In particular, the present invention introduces a wrench that can be used in a limited space. Moreover, the simplicity and effective design of the present invention allows greater convenience compared to existing wrenches.

### BRIEF DESCRIPTION OF THE DRAWINGS

FIG. 1 is a perspective view of the present invention.

FIG. 2 is another perspective view of the present invention.

FIG. 3 is a top view of the present invention.

FIG. 4 is a side view of the present invention.

FIG. 5 is a front view of the present invention.

FIG. 6 is a rear view of the present invention.

FIG. 7 is a top view of the present invention, wherein the first arm and the second arm is foldable.

FIG. 8 is an illustration of the present invention in use, wherein the fastener receiving head is engaged with a faucet bolt.

### DETAIL DESCRIPTIONS OF THE INVENTION

All illustrations of the drawings are for the purpose of describing selected versions of the present invention and are not intended to limit the scope of the present invention.

The present invention introduces an apparatus that can be used as an alternative to existing wrenches. Issues such as the lack of operating space can be effectively addressed by utilizing the present invention.

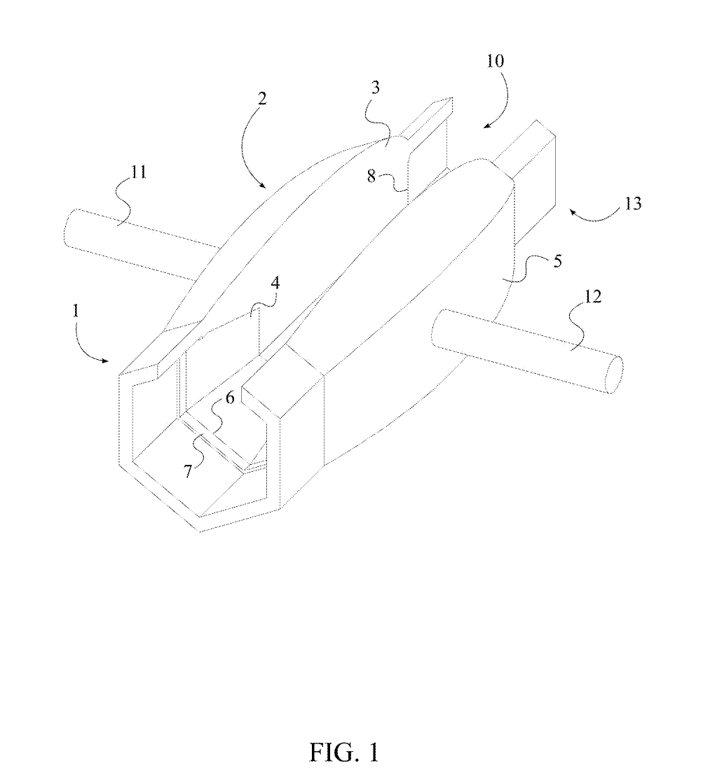

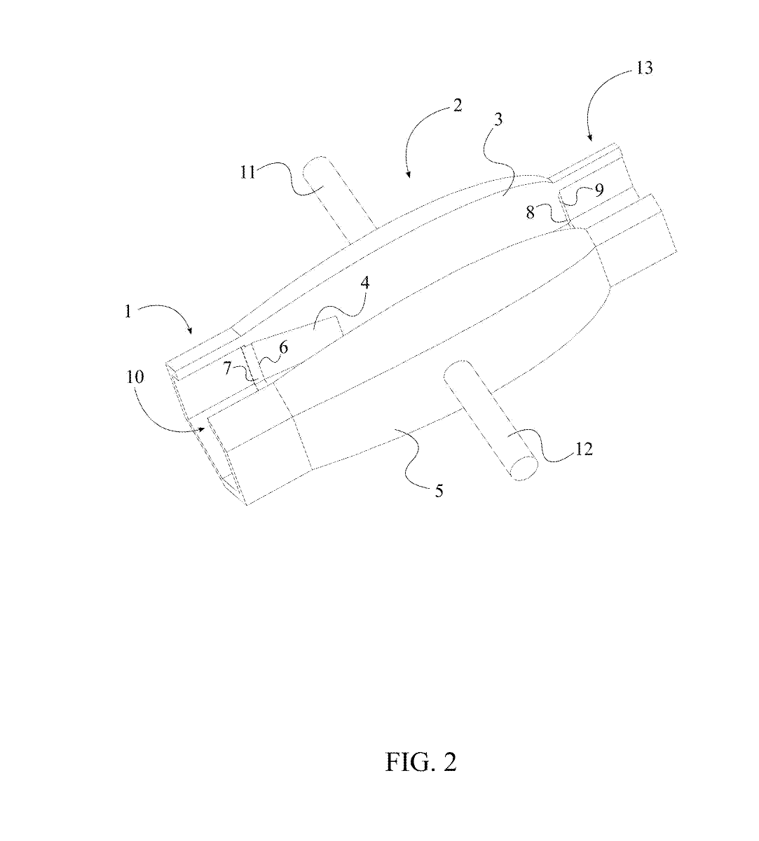

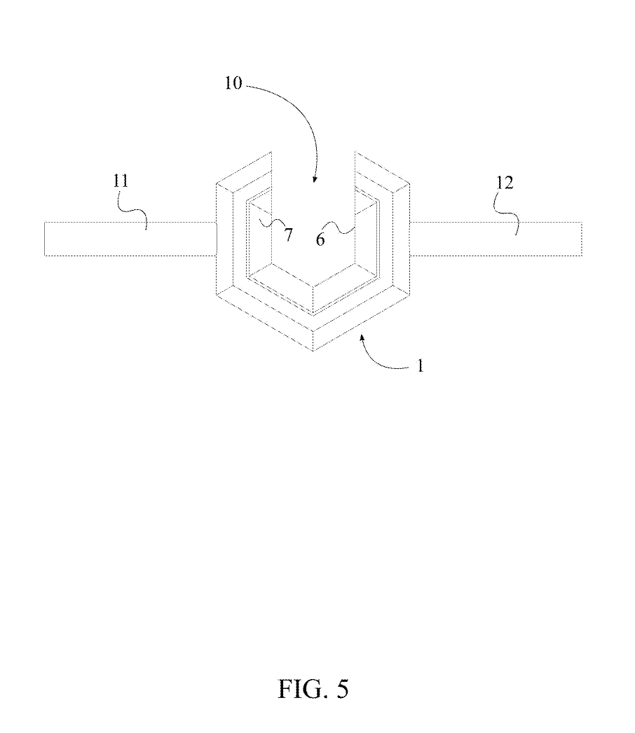

As illustrated in FIG. 1 and FIG. 2, the present invention comprises a fastener receiving head 1, a tubular body 2, a receiving channel 10, a first arm 11, and a second arm 12. The fastener receiving head 1 is used to engage with the bolt of a faucet supply line which needs to be fastened or unfastened. The size and shape of the fastener receiving head 1 can vary in different embodiments of the present invention to accommodate different bolt heads. In the preferred embodiment of the present invention, a transverse cross section of the fastener receiving head 1 is hexagonal as shown in FIG. 5. However, the cross section can also be octagonal or any other comparable shape in another embodiment of the present invention. When the fastener receiving head 1 is engaged with the bolt, the user needs to apply force in order to fasten or unfasten the bolt. When a traditional wrench is used, the force is applied by rotating the handle. However, when the present invention is used, the force is applied via the tubular body 2. The tubular body 2 comprises an inner surface 3, an outer surface 5, a first end 6, and a second end 8. A distance between the first end 6 and the second end 8 determines the length of the tubular body 2. Depending on the need, the length of the tubular body 2 can vary in different embodiments of the present invention. On the other hand, the distance between the outer surface 5 and the inner surface 3 determines the thickness of the tubular body 2. The thickness of the tubular body 2 can also vary in different embodiments of the present invention. A transverse cross section of the inner surface 3 is hexagonal in the preferred embodiment of the present invention. In order to apply force at the fastener receiving head 1 via the tubular body 2, the fastener receiving head 1 is adjacently connected to the tubular body 2 at the first end 6.

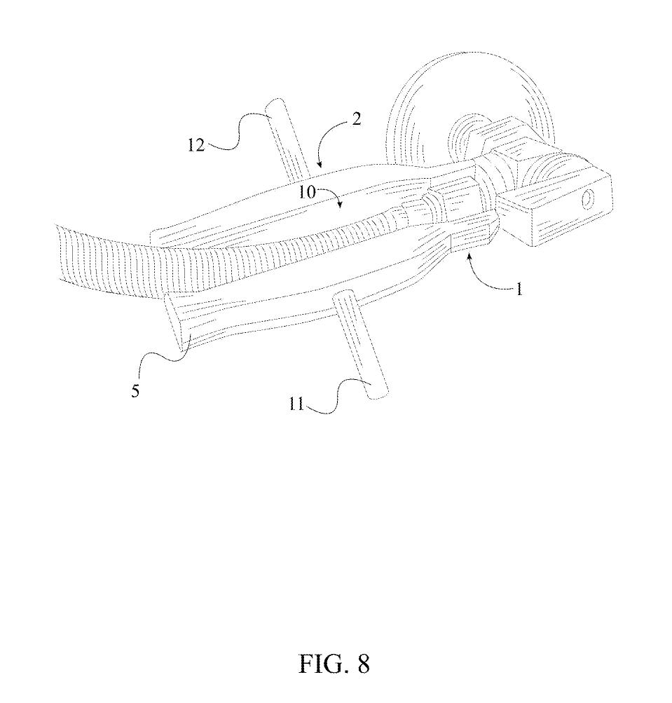

When controlling a bolt associated with a faucet, the supply line for the faucet is generally located in close proximity to the bolt. Therefore, the space for operation is limited. The receiving channel 10 addresses the issue by holding the supply line when the fastener receiving head 1 is engaged with the bolt. In order to do so, the receiving channel 10 laterally traverses through the outer surface 5 and the inner surface 3 so that the supply line can be positioned within the receiving channel 10 as seen in FIG. 8. Moreover, the receiving channel 10 longitudinally traverses through the tubular body 2 from the first end 6 to the second end 8 so that a firm hold can be maintained on the supply line when the present invention is being used. When the supply line is present, the supply line is immediately connected to the bolt. Therefore, in order to engage with the bolt and also to simultaneously position the supply line, the receiving channel 10 longitudinally traverses through the fastener receiving head 1 as well. The receiving channel 10 is sufficiently sized so that the supply line is pressed against the inner surface 3.

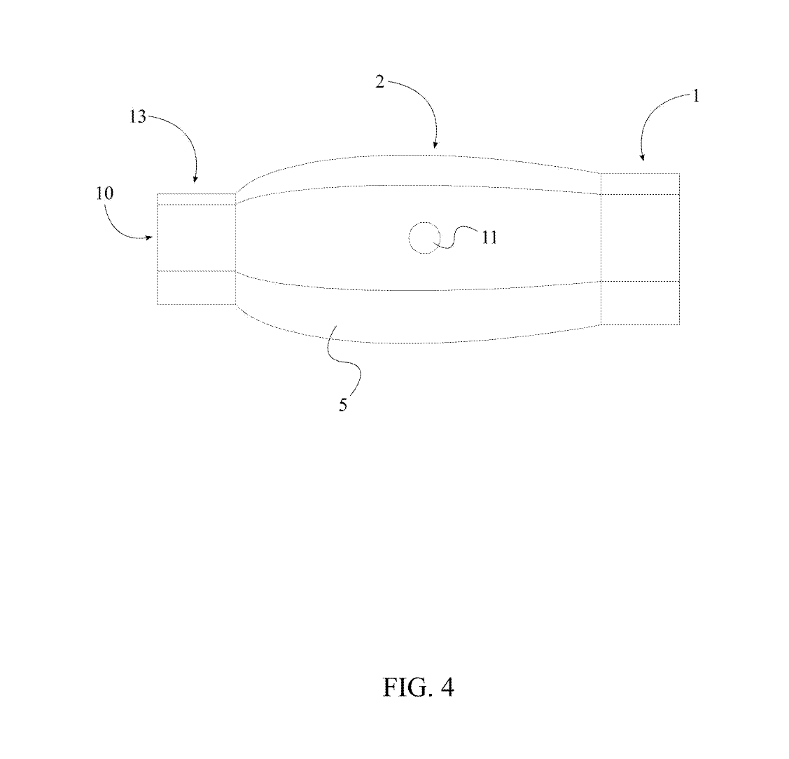

The first arm 11 and the second arm 12 are used to gain mechanical advantage when the present invention is being used. In particular, the first arm 11 and the second arm 12 can be used to rotate the tubular body 2 either clockwise or counter-clockwise as necessary. In order to do so, the first arm 11 and the second arm 12 are perpendicularly connected to the tubular body 2 at the outer surface 5. The perpendicular positioning allows the user to conveniently rotate the tubular body 2 with less effort. Moreover, the first arm 11 is positioned laterally opposite to the second arm 12 across the tubular body 2 so that the user can obtain the necessary mechanical advantage by grasping the first arm 11 and the second arm 12. When considering the position of the first arm 11 and the second arm 12 with respect to the receiving channel 10, the first arm 11 and the second arm 12 are oriented perpendicular to the receiving channel 10. In the preferred embodiment of the present invention, the first arm 11 and the second arm 12 are positioned laterally central to the outer surface 5 of the tubular body 2 as seen in FIG. 4. However, in another embodiment of the present invention, the first arm 11 and the second arm 12 can be positioned differently along the tubular body 2.

When the fastener receiving head 1 engages with the bolt, the bolt is pressed against an inner surface 3 of the fastener receiving head 1. In order to hold the bolt stationary within the fastener receiving head 1, the present invention comprises a stoppage band 7. Since the fastener receiving head 1 is connected to the tubular body 2 at the first end 6, the stoppage band 7 is positioned along the first end 6 so that the bolt does not move beyond the first end 6.

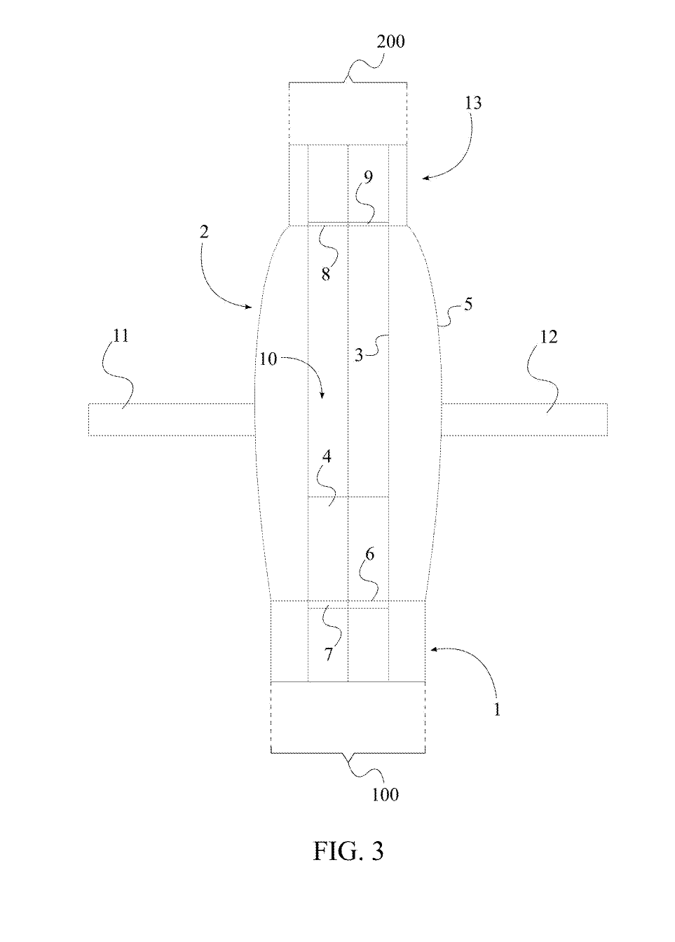

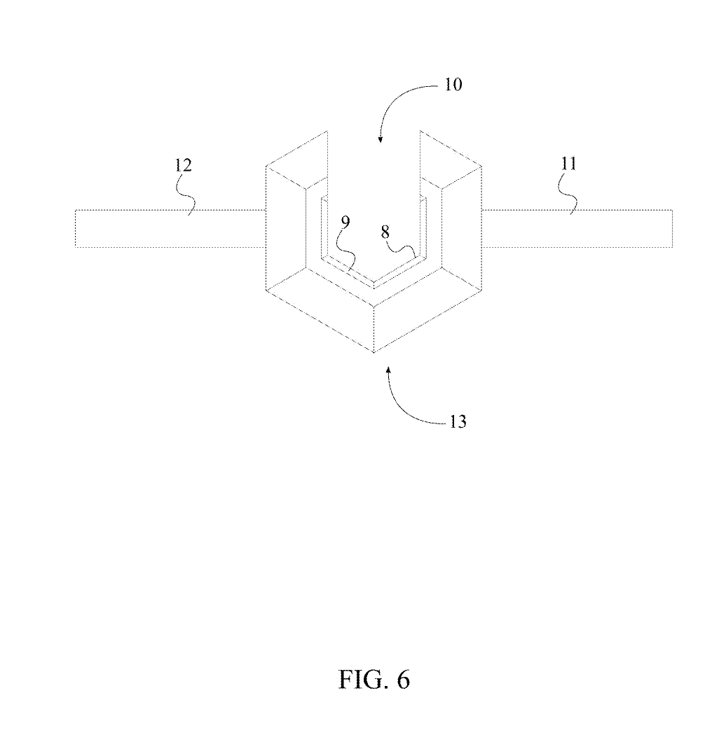

The size of the bolt that is being used with a faucet supply line can vary in size. In order to be used with the different bolt sizes, the present invention further comprises a secondary fastener receiving head 13. Similar to the fastener receiving head 1, the secondary fastener receiving head 13 is connected adjacent to the tubular body 2 at the second end 8 and opposite to the fastener receiving head 1. For the bolt to be pressed against the secondary fastener receiving head 13, and for the supply line to be positioned appropriately, the receiving channel 10 longitudinally also traverses through the secondary fastener receiving head 13. In order to maintain a firm grip with the bolt, the present invention further comprises a secondary stoppage band 9. Since the secondary fastener receiving head 13 is connected at the second end 8, the secondary stoppage band 9 is positioned along the second end 8 so that the bolt does not slide beyond the second end 8. As shown in FIG. 3, to accommodate different sized bolts, a diameter 100 of the fastener receiving head 1 is designed to be greater than a diameter 200 of the secondary fastener receiving head 13. However, in another embodiment of the present invention, the diameter 100 of the fastener receiving head 1 can be smaller than the diameter 200 of the secondary fastener receiving head 13. As shown in FIG. 6, a cross section of the secondary fastener receiving head 13 is also hexagonal.

Most faucet supply line bolts are attached to the supply line via a flange section. The presence of the flange section might hinder the ability to conveniently use the fastener receiving head 1 or the secondary fastener receiving head 13 since a firm grip cannot be established with the bolt. In order to address the issue, the inner surface 3 further comprises a tapered surface 4. The tapered surface 4 tapers inwards from the first end 6 towards the second end 8 so that a diameter at the first end 6 is larger than a diameter of the tapered surface 4. The additional space provided by the tapered surface 4 allows the user to utilize the present invention even when the flange section is present.

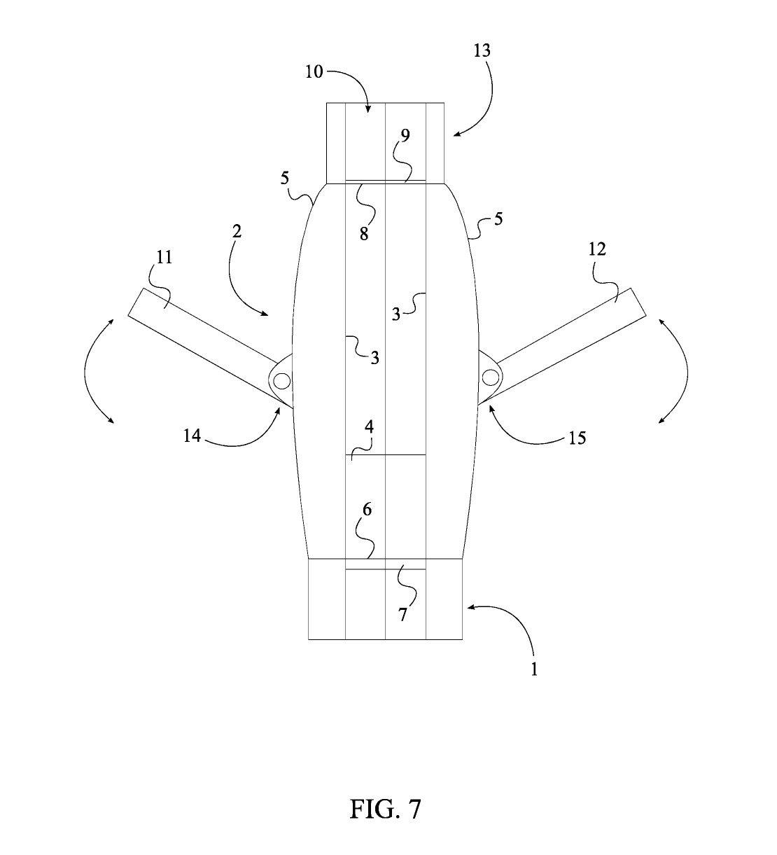

As mentioned before, the first arm 11 and the second arm 12 are perpendicularly fixed to the outer surface 5. With space limitations, the use of the first arm 11 and the second arm 12 can be restricted. As illustrated in FIG. 7, in another embodiment the present invention comprises a first hinging mechanism 14 and a second hinging mechanism 15 which are used to fold the first arm 11 and the second arm 12 respectively. More specifically, the first arm 11 is foldably connected to the outer surface 5 through the first hinging mechanism 14. Similarly, the second arm 12 is foldably connected to the outer surface 5 through the second hinging mechanism 15. Therefore, the position of the first arm 11 and the second arm 12 can be controlled independently.

When utilizing the present invention, the following process flow is generally followed. Initially, the fastener receiving head 1 or the secondary fastener receiving head 13 is selected according to the size of the bolt. When selected, the bolt is positioned within the fastener receiving head 1 or the secondary fastener receiving head 13 as necessary. Next, the supply line which is generally connected to the bolt, is positioned along the receiving channel 10 so that the bolt can be accessed with minimum obstruction. The user then grasps the first arm 11 and the second arm 12 and rotates the tubular body 2 in a clockwise or counter clockwise direction so that the bolt is either fastened or unfastened. If the first arm 11 and the second arm 12 are foldably connected, the first arm 11 and the second arm 12 are folded if necessary.

Although the invention has been explained in relation to its preferred embodiment, it is to be understood that many other possible modifications and variations can be made without departing from the spirit and scope of the invention as hereinafter claimed.

What is claimed is:

1. A faucet supply line wrench comprises:
a fastener receiving head;
a tubular body;
a receiving channel;
a first arm;
a second arm;
the tubular body comprises an inner surface, an outer surface, a first end, and a second end;
the fastener receiving head being connected adjacent to the tubular body at the first end;
the receiving channel laterally traversing through the outer surface and the inner surface;
the receiving channel longitudinally traversing through the tubular body from the first end to the second end;
the receiving channel longitudinally traversing through the fastener receiving head;
the first arm and the second arm being perpendicularly connected to the tubular body at the outer surface;
the first arm being positioned laterally opposite to the second arm across the tubular body; and
the first arm and the second arm being oriented perpendicular to the receiving channel.

2. The faucet supply line wrench as claimed in claim 1 further comprises:
a stoppage band; and
the stoppage band being positioned along the first end.

3. The faucet supply line wrench as claimed in claim 1 further comprises:
the inner surface further comprises a tapered surface; and
the tapered surface being tapered inward from the first end towards the second end.

4. The faucet supply line wrench as claimed in claim 1 further comprises:
a secondary fastener receiving head;
the secondary fastener receiving head being connected adjacent to the tubular body at the second end opposite to the fastener receiving head; and
the receiving channel longitudinally traversing through the secondary fastener receiving head.

5. The faucet supply line wrench as claimed in claim 4 further comprises:
a secondary stoppage band; and
the secondary stoppage band being positioned along the second end.

6. The faucet supply line wrench as claimed in claim 4, wherein a diameter of the fastener receiving head is greater than a diameter of the secondary fastener receiving head.

7. The faucet supply line wrench as claimed in claim 1 further comprises:
a first hinging mechanism;
a second hinging mechanism;
the first arm being foldably connected to the outer surface through the first hinging mechanism; and
the second arm being foldably connected to the outer surface through the second hinging mechanism.

8. The faucet supply line wrench as claimed in claim 1, wherein the first arm and the second arm are positioned laterally central to the outer surface of the tubular body.

9. The faucet supply line wrench as claimed in claim 1, wherein a transverse cross section of the inner surface is hexagonal.
